(19) United States
(12) Patent Application Publication
(10) Pub. No.: US 2025/0341638 A1
(43) Pub. Date: Nov. 6, 2025

(54) OBJECT TRACKER AND METHOD THEREOF

(71) Applicant: DIGANTARA RESEARCH AND TECHNOLOGIES PRIVATE LIMITED, Kotdwara (IN)

(72) Inventors: Tanveer AHMED, Bengaluru (IN); Sapireddy SRINIVASU, East Godavari (IN); Rahul RAWAT, Kotdwara (IN); Anirudh N SHARMA, Bengaluru (IN)

(21) Appl. No.: 19/126,270

(22) PCT Filed: Nov. 1, 2023
(86) PCT No.: PCT/IB2023/061009

§ 371 Date: May 1, 2025

(30) Foreign Application Priority Data
Nov. 1, 2022 (IN) 202211056547

(51) Int. Cl. G01S 17/66; B64G 3/00; G01S 7/48; G01S 7/481; G01S 17/04; G01S 17/58; G01S 17/86

(52) U.S. Cl. CPC G01S 17/66; B64G 3/00; G01S 7/4802; G01S 7/4814; G01S 7/4816; G01S 17/04; G01S 17/58; G01S 17/86

(57) ABSTRACT

Disclosed is an object tracker (106) having an imaging unit (202) and a light detection and ranging (LIDAR) unit (204). The imaging unit (202) is configured to capture one or more images of space around the object tracker (106) to search for a resident space object (RSO) (102a) in the space. Upon detection of the RSO (102a), the imaging unit (202) determines a first set of attributes of the RSO (102a). The LIDAR unit 204 is configured to activate upon receipt of the first set of attributes from the imaging unit (202) such that the LIDAR unit (204) emits, based on the first set of attributes, a laser beam towards the RSO (102a) to determine a second set of attributes of the RSO (102a).

### TECHNICAL FIELD

The present disclosure relates generally to the field of space applications. More particularly, the present disclosure relates to an object tracker and a method thereof.

### BACKGROUND

There are various requirements of studying space objects in order to observe space activities. There are various space situational awareness programs that are executed to read the activities that are happening in space.

Conventional techniques of understanding the space uses ground mounted infrastructures which are not that efficient in retrieving information about the space objects. Various atmospheric losses cause the ground mounted facilities to capture very less information about the space objects. The ground mounted facilities are only able to track only 4% of the lethal space objects.

Furthermore, the ground mounted facilities are not capable of detecting the resident space objects of various sizes, specifically the ground mounted facilities are not capable of detecting small sized resident space objects. This causes retrieval of incomplete information about the space objects and thereby affects the planning of space missions. Furthermore, ground mounted facilities are incompetent in retrieving sufficient information due to atmosphere. Sensors of the ground mounted facilities are not able to operate during rainfall or snowfall that affects the working of the sensors and thereby deteriorating the signal/data quality sensed by the sensors.

Thus, there is a need for a technical solution that overcomes the aforementioned problems of conventional space object tracking systems.

### SUMMARY

In view of the foregoing, an object tracker is disclosed. The object tracker includes an imaging unit and a light detection and ranging (LIDAR) unit. The imaging unit is configured to capture one or more images of space around the object tracker to search for a resident space object (RSO) in the space. Upon detection of the RSO, the imaging unit determines a first set of attributes of the RSO at a first time interval (t1). The LIDAR unit is coupled to the imaging unit and configured to activate upon receipt of the first set of attributes from the imaging unit such that the LIDAR unit emits, based on the first set of attributes, a laser beam towards the RSO to determine a second set of attributes of the RSO at a second time interval (t2).

In some embodiments of the present disclosure, the object tracker further includes processing circuitry coupled to the imaging unit and the LIDAR unit. The processing circuitry is configured to determine a position of the RSO based on the first and second sets of attributes.

In some embodiments of the present disclosure, the LIDAR unit includes a transmitter and a receiver. The transmitter is configured to transmit the laser beam towards the RSO. The receiver is configured to receive reflected version of the laser beam upon striking of the laser beam with the RSO. The laser beam and the reflected version of the laser beam facilitates to determine the second set of attributes.

In some embodiments of the present disclosure, the transmitter includes a laser mechanism, a divergence mechanism, and a steering mechanism. The laser mechanism is configured to produce the laser beam. The divergence mechanism is coupled to the laser mechanism and configured to facilitate divergence of the laser beam. The steering mechanism coupled to the divergence mechanism and configured to guide the laser beam based on the first set of attributes such that the laser beam strikes the RSO.

In some embodiments of the present disclosure, the receiver includes a photodetector and a pair of filters. The photodetector, based on the laser beam and the reflected version of the laser beam, determines the second set of attributes. The pair of filters are disposed ahead of the photodetector such that the pair of filters reduce noise level of the reflected version of the laser beam.

In some embodiments of the present disclosure, the photodetector is a single photon avalanche diode.

In some embodiments of the present disclosure, the first set of attributes includes an azimuthal angle and an elevation angle associated with the RSO.

In some embodiments of the present disclosure, the second set of attributes includes a range associated with the RSO.

In some aspects of the present disclosure, a method for tracking a resident space object is disclosed. The method includes a step of capturing, by way of an imaging unit, one or more images of space around an object tracker. The method further includes a step of searching, by way of the imaging unit, for the RSO in the space. The method further includes a step of determining, by way of the imaging unit, a first set of attributes of the RSO at a first time interval (t1) upon detection of the RSO. The method further includes a step of emitting, by way of a light detection and ranging (LIDAR) unit coupled to the imaging unit, a laser beam towards the RSO based on the first set of attributes. The method further includes a step of determining, by way of the LIDAR unit, a second set of attributes of the RSO at a second time interval (t2) upon receiving the reflected version the laser beam.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates an exemplary scenario to track a plurality of resident space objects (RSOs), in accordance with an embodiment of the present disclosure;

FIG. 2 illustrates a schematic view of an object tracker, in accordance with an embodiment of the present disclosure;

FIG. 3 illustrates a schematic view of a light detection and ranging (LIDAR) unit of the object tracker of FIG. 2, in accordance with an embodiment of the present disclosure; and

FIG. 4 illustrates a flowchart that depicts a method for tracking the resident space object, in accordance with an embodiment of the present disclosure.

To facilitate understanding, like reference numerals have been used, where possible, to designate like elements common to the figures.

### DETAILED DESCRIPTION

Various aspects of the present disclosure provide an object tracker and a method thereof. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described specifically to meet statutory requirements. However, the description itself is not intended to limit the scope of this disclosure. Rather, the inventor/inventors have contemplated that the claimed subject matter might also be embodied in other ways, to include different features or combinations of features similar to the ones described in this document, in conjunction with other technologies. Generally, the various aspects including the example aspects relate to an object tracker and a method thereof.

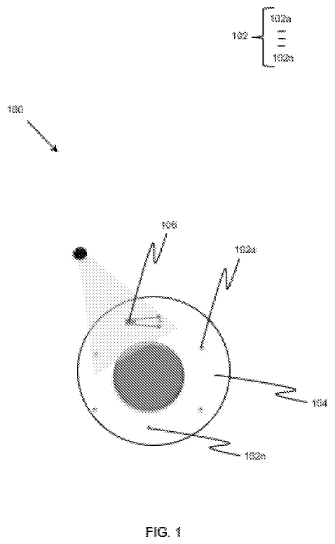

FIG. 1 illustrates an exemplary scenario 100 to track a plurality of resident space objects 102a-102n (hereinafter collectively referred to and designated as “the resident space objects (RSOs) 102” and individually referred to and designated as “the resident space object (RSO) 102a”), in accordance with an embodiment of the present disclosure. The exemplary scenario 100 may include a low earth orbit (LEO) region 104 of space. The RSOs 102 may be present in the LEO region 104 such that the RSOs moves in the LEO region 104. Each RSO of the RSOs 102 may be an object that may reside in the space. The RSOs may be tracked by way of an object tracker 106. In other words, the object tracker 106 may be configured to track the RSOs to retrieve information about the RSOs. The object tracker 106 may be configured to orbit in the space while tracking the RSOs. Specifically, the object tracker 106 may be configured to orbit in the LEO region 104 while tracking the RSOs 102.

In some embodiments of the present disclosure, the RSOs 102 may be present at other regions of the space, for example, the RSOs 102 may be present outside of the LEO region 104. The object tracker 106 may be adapted to track the RSOs 102 that may be present outside the LEO region 104. The object tracker 106 may be deployed in the LEO region 104 to track the RSOs 102 that may be present outside the LEO region 104. In some embodiments of the present disclosure, the object tracker 106 may be deployed in any part of the space such that the object tracker 106 tracks the RSOs 102 that may be present at any part of the space.

In some embodiments of the present disclosure, the object tracker 106 may be configured to track the RSOs 102 with fixed and varying range.

In some embodiments of the present disclosure, each RSO of the RSOs 102 may have a diameter that may be in a range of 1 centimetre to 25 centimetres (cm). In other words, the object tracker 106 may be adapted to track the RSOs 102 of diameter having a range of the 1 cm to 25 cm. In some embodiments of the present disclosure, each RSO of the RSOs 102 may have the diameter that may be greater than 25 cm. In other words, the object tracker 106 may be adapted to track the RSOs 102 of diameter greater than 25 cm. Embodiments of the present disclosure are intended to include and/or otherwise cover any diameter/size of the RSO of the RSOs 102, without deviating from the scope of the present disclosure. Preferably, each RSO of the RSOs 102 may have the diameter that may be 10 cm. Each RSO of the RSOs 102 may have a reflectivity value that may be in a range of 5% to 14%. Preferably, each RSO of the RSOs may have the reflectivity that may be 10%. In other words, the object tracker 106 may be adapted to track the RSOs 102 with different brightness, for example, light or faint RSOs 102, dark RSOs 102. Embodiments of the present disclosure are intended to include and/or otherwise cover the RSOs 102 with different reflectivity value, without deviating from the scope of the present disclosure.

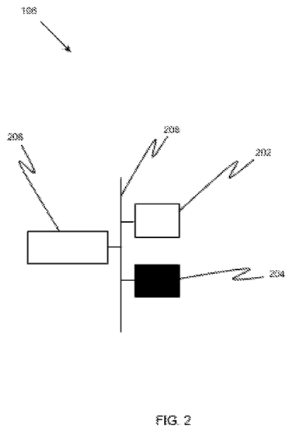

FIG. 2 illustrates a schematic view of the object tracker 106, in accordance with an embodiment of the present disclosure. The object tracker 106 may be configured to track the RSOs 102. Specifically, the object tracker 106 may be configured to track the RSOs 102 to determine information about the RSOs 102. For example, the object tracker 106 may be configured to track the RSOs 102 to determine an angular position and a range (distance) of the RSOs 102 from the object tracker 106 in the space. Specifically, the object tracker 106 may be configured to track the RSOs 102 to determine the position of the RSOs 102 based on the angular position of the RSOs 102 and the range of the RSOs 102.

In some exemplary embodiments of the present disclosure, the object tracker 106 may be configured to track the RSO 102a that may be at a distance of 0.25 Kilometres (Km) to 250 Km from the object tracker 106. Preferably, the object tracker 106 may be configured to track the RSO 102a of 10 cm size from a distance of about 100 Km. Embodiments of the present disclosure are intended to include and/or otherwise cover any distance from the object tracker 106 and any size of the RSOs 102 in order to track the RSOs 102 by the object tracker 106, without deviating from the scope of the present disclosure.

In some embodiments, the object tracker 106 may exhibit a modular design such that the form factor of the object tracker 106 allows the object tracker 106 to be implemented in multiple satellites or other space-based platforms.

In some embodiments of the present disclosure, the object tracker 106 may be configured conduct offensive and defensive countermeasures and perform orbital inspection during proximity operations.

In some embodiments, the object tracker 106 may be configured to track different sized RSOs, for example, the object tracker 106 may be configured to track small sized RSO.

In some embodiments, the object tracker 106 may include a plurality of thrust engines such that the plurality of thrust engines when activated, causes change in orbital motion of the object tracker 106.

In some embodiments of the present disclosure, the object tracker 106 may have an exposure time that may be in a range of 1 millisecond (ms) to 10 seconds. The term “exposure time” as used herein refers to time duration for which the object tracker 106 may be configured to collect reflected or scattered sunlight from the RSO 102a. Embodiments of the present disclosure are intended to include and/or otherwise cover any range or value for the exposure time, without deviating from the scope of the present disclosure.

In some embodiments of the present disclosure, the object tracker 106 may have an operational temperature that may be in a range of −15 degrees Celsius (° C.) to 60° C. The term “operational temperature” as used herein refers to a temperature at which the object tracker 106 may be configured to perform one or more operations that may facilitate the object tracker 106 to determine information such an angular position and a range of the RSO 102a. Embodiments of the present disclosure are intended to include and/or otherwise cover any range or value for the operational temperature of the object tracker 106, without deviating from the scope of the present disclosure.

In some embodiments of the present disclosure, the object tracker 106 may have a storage temperature that may be in a range of −25° C. to 75° C. The term “storage temperature” as used herein refers to temperature in which the object tracker 106 may be stored i.e., when the object tracker 106 is not operational. Embodiments of the present disclosure are intended to include and/or otherwise cover any range or value for the storage temperature of the object tracker 106, without deviating from the scope of the present disclosure.

In some embodiments of the present disclosure, the object tracker 106 may be configured in co-ordination with one or more ground mounted facilities to retrieve information about the RSO 102a.

The object tracker 106 may include an imaging unit 202, a light detection and ranging (LIDAR) unit 204, and processing circuitry 206. The imaging unit 202, the LIDAR unit 204, and the processing circuitry 206 may be coupled to each other by way of a communication channel 208.

In some embodiments of the present disclosure, the communication channel 208 may be implemented with “camera link”, low voltage differential signaling (LVDS), “standard communication protocol” or “communication protocol” that may include Inter-Integrated Circuit (I2C), Serial Peripheral Interface (SPI), Universal Asynchronous Receiver/Transmitter (UART) or the like communication protocols.

The imaging unit 202 may be configured to capture one or more images of the space around the object tracker 106. Specifically, the imaging unit 202 may be configured to capture the one or more images to search for the RSO 102a in the space. The imaging unit 202 may be configured to search for the RSO 102a that may be present in a field of view (FOV) of the imaging unit 202. The imaging unit 202 may be configured to determine a first set of attributes of the RSO 102a upon detection of the RSO 102a in the space. Specifically, the imaging unit 202 may be configured to determine the first set of attributes of the RSO 102a at a first time interval (t1). The first set of attributes may include, but not limited to, an azimuthal angle and an elevation angle associated with the RSO 102a. The first set of attributes of the RSO 102a may represent an angular position of the RSO 102a in the LEO region 104 at the first time interval (t1). The imaging unit 202 may be configured to transmit the first set of attributes to the LIDAR unit 204. Specifically, the imaging unit 202 may be configured to transmit the first set of attributes to the LIDAR unit 204 by way of the communication channel 208.

In some embodiments, the imaging unit 202 may be one of, a visible and near-infrared (VNIR) camera, a short-wave infrared (SWIR) camera, a long-wave infrared (LWIR), a panchromatic camera (PAN), a linear imaging self-scanning sensor (LISS-3), and wide field sensors (Wi-FS). Embodiments of the present disclosure are intended to include and/or otherwise cover any type of the imaging unit 202, without deviating from the scope of the present disclosure.

In some embodiments of the present disclosure, the imaging unit 202 may be configured to capture the one or more images such that each image of the one or more images may have a pixel resolution that may be in a range of 512*512 to 2048*2048. Embodiments of the present disclosure are intended to include and/or otherwise cover any range and value for the pixel resolution, without deviating from the scope of the present disclosure.

In some embodiments of the present disclosure, the imaging unit 202 may have a quantum efficiency that may lie in a range of 50% to 70%. Preferably, the quantum efficiency of the imaging unit 202 may be 60%. Embodiments of the present disclosure are intended to include and/or otherwise cover any value or range for the quantum efficiency of the imaging unit 202, without deviating from the scope of the present disclosure.

In some embodiments of the present disclosure, the imaging unit 202 may have the field of view (FOV) that may be in a range of 0.5 rad*0.5 rad to 1.5 rad*1.5 rad. The term “field of view” as used herein refers to a solid angle associated with a total area that may be captured by the imaging unit 202. Embodiments of the present disclosure are intended to include and/or otherwise cover any value or range for the field of view of the imaging unit 202, without deviating from the scope of the present disclosure.

In some embodiments of the present disclosure, a read-out noise (RMS) (e/pixel) value of the imaging unit 202 may be less than 5. The term “read out noise” as used herein refers to the noise that may be introduced during analogue to digital conversion of the sunlight reflected from the RSO 102a. Embodiments of the present disclosure are intended to include and/or otherwise cover any range or value for the read-out noise value of the imaging unit 202, without deviating from the scope of the present disclosure.

In some embodiments of the present disclosure, value of dark noise (e/pixel/second) for the imaging unit 202 may be less than 250. The term “dark noise” as used herein refers to random generation of electrons, mainly due to temperature, in pixels of the imaging unit 202. In some embodiments, value of each grayscale of the image captured by the imaging unit 202 may be 3 e−. Embodiments of the present disclosure are intended to include and/or otherwise cover any range or value for the dark noise and grayscale value of the imaging unit 202, without deviating from the scope of the present disclosure.

In some embodiments of the present disclosure, the first set of attributes may include, but not limited to, an angular velocity of the RSO 102a and an angular acceleration of the RSO 102a. Embodiments of the present disclosure are intended to include and/or otherwise cover any type of the first set of attributes that may be indicative of the angular position, angular velocity and angular acceleration of the RSO 102a, without deviating from the scope of the present disclosure.

In some embodiments of the present disclosure, the first set of attributes may include, but not limited to, brightness intensity and optical cross-section associated with the RSO 102a. Specifically, the imaging unit 202 may be adapted to determine one or more optical signatures of the RSO 102a based on brightness intensity and the optical cross-section. The optical signatures of the RSO 102a may include, but not limited to, size of the RSO 102a, shape of the RSO 102a, and spin of the RSO 102a.

The LIDAR unit 204 may be coupled to the imaging unit 202. Specifically, the LIDAR unit 204 may be coupled to the imaging unit 202 by way of the communication channel 208. The LIDAR unit 204 may be configured to receive the first set of attributes from the imaging unit 202. Specifically, the LIDAR unit 204 may be configured to receive the first set of attributes from the imaging unit 202 through the communication channel 208. The LIDAR unit 204 may be configured to activate upon receipt of first set of attributes from the imaging unit 202. The LIDAR unit 204 may be configured to emit a laser beam towards the RSO 102a upon activation. The term “activation” as used herein refers to one of, a cold start or a hot start of the transmitter 302. The term “activation” as used herein also refers to re-orientation of the transmitter 302 such that the transmitter 302 transmits the laser beam in a desired direction i.e., towards the RSO 102a. The LIDAR unit 204 may be configured to emit the laser beam towards the RSO 102a based on the first set of attributes. In other words, the LIDAR unit 204 may emit the laser beam at the angular position of the RSO 102a that may advantageously facilitate the laser beam to efficiently strike on the RSO 102a. Since, the object tracker 106 and the RSO 102a exhibit motion in the space, therefore, relative position of the RSO 102a may vary with respect to the position of the object tracker 106. Preferably the LIDAR unit 204 may emit the laser beam based on a relative angular position of the RSO 102a with respect to the object tracker 106. Thus, the LIDAR unit 204 advantageously facilitate to emit the laser beam towards the RSO 102a without any deviation from the RSO 102a. Specifically, the LIDAR unit 204 may be configured to emit the laser beam towards the RSO 102a and to receive a reflected version of the laser beam upon striking of the laser beam with the RSO 102a. The LIDAR unit 204 may be further configured to determine a second set of attributes of the RSO 102a at a second time interval (t2). Specifically, the LIDAR unit 204 may determine the second set of attributes based on the laser beam and the reflected version of the laser beam. The LIDAR unit 204 may be configured to employ one of, a coincidence processing technique and a time correlated single photon counting technique to determine the second set of attributes of the RSO 102a. The second set of attributes of the RSO 102a may include, but not limited to, a range of the RSO 102a at the second time interval (t2). In some preferred examples of the present disclosure, the LIDAR unit 204 may be configured to employ one of, the coincidence processing technique and the time correlated single photon counting technique to determine the range of the RSO 102a at the second time interval (t2). The laser beam may have a pulse repetition rate (PRR) value that may be in a range of 0.25 Kilo-Hertz (kHz) to 1 kHz. Embodiments of the present disclosure are intended to include and/or otherwise cover any value or range for the PRR value of the laser beam, without deviating from the scope of the present disclosure.

In some embodiments of the present disclosure, wavelength of the laser beam may be beyond wavelength of solar radiation. The term “solar radiation” as used herein may refer to noise of the LIDAR unit 204. The wavelength of the solar radiation may be in a range of 400 nm to 1000 nm with peak radiation level at 500 nm. In order to reduce noise for the LIDAR unit 204, the wavelength of the laser beam may be preferably kept outside of the wavelength of the solar radiation. Embodiments of the present disclosure are intended to include and/or otherwise cover any range or value for the wavelength of the laser beam, without deviating from the scope of the present disclosure.

In some embodiments of the present disclosure, the LIDAR unit 204 may employ one of, a pseudo random technique and a multiple PRR technique to determine the second set of attributes of the RSO 102a. Due to increased PRR value, trouble in determining the range of the RSO 102a arises. The pseudo random technique and the multiple PRR technique may advantageously eliminate the trouble of ambiguity in determining the range of the RSO 102a.

In some embodiments of the present disclosure, the second set of attributes of the RSO 102a may include, but not limited to, intensity values and LIDAR cross section associated to the RSO 102a. The intensity values and the LIDAR cross section may facilitate to determine shape of the RSO 102a, size of the RSO 102a, and spin of the RSO 102a. The processing circuitry 206 may be coupled to the imaging unit 202 and the LIDAR unit 204. The processing circuitry 206 may be configured to receive the first set of attributes from the imaging unit 202 and the second set of attributes from the LIDAR unit 204. Specifically, the processing circuitry 206 may be configured to receive the first and second sets of attributes from the imaging unit 202 and the LIDAR unit 204, respectively, through the communication channel 208. The processing circuitry 206 may be configured to determine the position, velocity, acceleration, orbit or state vector and trajectory associated with the RSO 102a. Specifically, the processing circuitry 206 may be configured to determine the position, velocity, acceleration, orbit or state vector and trajectory of the RSO 102a based on the first and second set of attributes. For example, the processing circuitry 206 may be configured to determine the position, velocity, acceleration, orbit or state vector and trajectory of the RSO 102a based on the angular position and the range of the RSO 102a. The position of the RSO 102a may represent spatial position of the RSO 102a.

In some embodiments of the present disclosure, the processing circuitry 206 may be configured to determine the first and second sets of attributes of the RSO 102a. In such a scenario, the first and second sets of attributes of the RSO 102a may not be determined by the imaging unit 202 and the LIDAR unit 204, respectively. Rather, the processing circuitry 206 may be configured to determine the first and second sets of attributes of the RSO 102a.

Although FIG. 2 illustrates that the object tracker 106 includes one imaging unit 202 and one LIDAR unit 204, it will be apparent to a person skilled in the art that the scope of the present disclosure is not limited to it. In various other aspects, the object tracker 106 may include multiple imaging units without deviating from the scope of the present disclosure. In such a scenario, each imaging unit of the multiple imaging units is configured to perform one or more operations in a manner similar to the operations of the imaging unit 202 and the LIDAR unit 204 as described hereinabove. The objective of employing multiple imaging units and the LIDAR units in the object tracker 106 may be to increase coverage of the imaging unit 202 and to increase accuracy in determining the first and second sets of attributes associated with the RSO 102a.

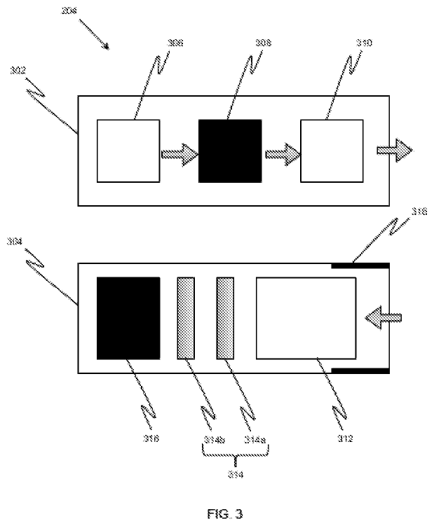

FIG. 3 illustrates a schematic view of the light detection and ranging (LIDAR) unit 204 of the object tracker 106 of FIG. 2, in accordance with an embodiment of the present disclosure. The LIDAR unit 204 may include a transmitter 302 and a receiver 304. The transmitter 302 may include a laser mechanism 306, a divergence mechanism 308, and a steering mechanism 310. The receiver 304 may include a beam focusing mechanism 312, a pair of filters 314a, 314b (hereinafter collectively referred to and designated as “the filters 314”), and a photodetector 316.

The transmitter 302 may be configured to transmit the laser beam towards the RSO 102a. Specifically, the transmitter 302 may be configured to transmit the laser beam towards the RSO 102a based on the first set of attributes. The laser mechanism 306 may be configured to produce or generate the laser beam. In some examples of the present disclosure, the laser mechanism 306 may be configured to produce pulse laser beam. The laser mechanism 306 may be configured to produce the laser beam such that the PRR value of the laser beam lies in a range of 0.25 kHz to 1 kHz. Embodiments of the present disclosure are intended to include and/or otherwise cover any value for the PRR, without deviating from the scope of the present disclosure. The divergence mechanism 308 may be coupled to the laser mechanism 306. Specifically, the divergence mechanism 308 may be coupled downstream to the laser mechanism 306 i.e., the laser beam may be travelled towards the divergence mechanism 308 from the laser mechanism 306. The divergence mechanism 308 may be configured to facilitate variation in divergence of the laser beam. The divergence of the laser beam may refer to an angle of a cone shape that may be formed as a path of the laser beam. The divergence mechanism 308 may be an optical set up i.e., the divergence mechanism 308 may be a set of optical lenses or mirrors. The set of optical lenses or mirrors may be arranged or positioned with respect to each other that may facilitate divergence of the laser beam i.e., that may facilitate to produce the laser beam of desired size. The steering mechanism 310 may be coupled to the divergence mechanism 308. Specifically, the steering mechanism 310 may be coupled downstream to the divergence mechanism 308 i.e., the laser beam may be travelled towards the steering mechanism 310 from the divergence mechanism 308. The steering mechanism 310 may be configured to guide the laser beam based on the first set of attributes such that the laser beam is directed towards the RSO 102a. Specifically, the steering mechanism 310 may be configured to guide the laser beam based on the angular position and relative velocity of the RSO 102a with respect to the object tracker 106. Thus, the steering mechanism 310 may advantageously facilitate to guide the laser beam towards the RSO 102a. In some embodiments of the present disclosure, the transmitter 302 may have an optical aperture that may be in a range of 80 millimeters (mm) to 100 mm. Preferably, the transmitter 302 may have the optical aperture that may be 90 mm. Embodiments of the present disclosure are intended to include and/or otherwise cover any range or value for the optical aperture of the transmitter 302, without deviating from the scope of the present disclosure.

In some embodiments of the present disclosure, the laser beam may have a pulse energy that may be in a range of 40 millijoule (mJ) to 80 mJ. The laser beam may have an average power that may be in a range of 15 Watt (W) to 25 W. Preferably, the laser beam may have an average power that may be 20 W. The laser beam may have a pulse width that may be in a range of 2 nano-seconds (ns) to 15 ns. Preferably, the laser beam may have the pulse width that may be less than 10 ns. The laser beam may have a wavelength that may be in a range of 500 nanometer (nm) to 550 nm. Preferably, the laser beam may have the wavelength that may be 532 nm. Embodiments of the present disclosure are intended to include and/or otherwise cover any range or value for the pulse energy of the laser beam, average power of the laser beam, pulse width of the laser beam, and wavelength of the laser beam, without deviating from the scope of the present disclosure.

In some embodiments of the present disclosure, the divergence mechanism 308 may facilitate the divergence of the laser beam such that a beam divergence angle of the laser beam may be in a range of 60 micro-radians (urad) to 80 μrad. Preferably, the laser beam may have the beam divergence angle that may be 70 urad. Embodiments of the present disclosure are intended to include and/or otherwise cover any range or value for the divergence of the laser beam, without deviating from the scope of the present disclosure.

In some embodiments of the present disclosure, the transmitter 302 may have an optical transmission efficiency that may be in a range of 0.7 to 0.9. Preferably, the transmitter 302 may have the optical transmission efficiency that may be 0.8. Embodiments of the present disclosure are intended to include and/or otherwise cover any value for the optical transmission efficiency for the transmitter 302, without deviating from the scope of the present disclosure.

In some embodiments of the present disclosure, the transmitter 302 may be adapted to transmit the laser beam having a linewidth that may be in a range of 3 nanometres (nm) to 6 nm. Preferably, the transmitter 302 may be adapted to transmit the laser beam having the linewidth that may be 5 nm. Embodiments of the present disclosure are intended to include and/or otherwise cover any range or value for the linewidth of the laser beam, without deviating from the scope of the present disclosure.

In some embodiments of the present disclosure, the steering mechanism 310 may have a steering range that may be 30 Degrees. Embodiments of the present disclosure are intended to include and/or otherwise cover any range or value for the steering range of the steering mechanism 310, without deviating from the scope of the present disclosure. The receiver 304 may be configured to receive the reflected version of the laser beam upon striking of the laser beam with the RSO 102a. The receiver 304 may be further configured to determine the second set of attributes based on the laser beam and the reflected version of the laser beam upon striking of the laser beam with the RSO 102a. In other words, the laser beam and the reflected version of the laser beam may facilitate to determine the second set of attributes. Specifically, the laser beam and the reflected version of the laser beam may facilitate to determine the range of the RSO 102a.

Preferably, the PRR value of the laser beam may be kept low. The low PRR value of the laser beam may advantageously facilitate the receiver 304 to analyse multiple pulses of the reflected version of the laser beam in 1 to 2 seconds. The low PRR value may advantageously facilitate the LIDAR unit to process more data such that the determination of the second set of attributes is accurate. Thus, the low PRR value i.e., in range of 0.25 kHz to 1 kHz for the laser beam may increase efficiency of the LIDAR unit 204.

In some embodiments of the present disclosure, the receiver 304 may have an optical aperture diameter that may be in a range of 50 mm to 80 mm. Preferably, the receiver 304 may have the optical aperture diameter that may be 70 mm. Embodiments of the present disclosure are intended to include and/or otherwise cover any value or range for the optical aperture diameter of the receiver 304, without deviating from the scope of the present disclosure. The receiver 304 may have an efficiency that may be in a range of 0.7 to 0.9. Preferably, the receiver 304 may have the efficiency that may be 0.83. Embodiments of the present disclosure are intended to include and/or otherwise cover any value of the efficiency of the receiver 304, without deviating from the scope of the present disclosure.

In some embodiments of the present disclosure, the receiver 304 may have a photon detection efficiency (PDE) value that may be in a range of 0.10 to 0.20. The term “photon detection efficiency (PDE)” as used herein refers to conversion efficiency of the receiver 304 where the receiver 304 converts photons to electrons. The PDE value may be a product between quantum efficiency and fill factor. Preferably, the receiver 304 may have the photon detection efficiency (PDE) value that may be 0.15. The PDE value may be preferably higher to achieve better results. Specifically, the PDE value may be preferably higher that may facilitate conversion of maximum photons to electrons. Embodiments of the present disclosure are intended to include and/or otherwise cover any value or range for the PDE, without deviating from the scope of the present disclosure.

In some embodiments of the present disclosure, the receiver 304 may have a dark count rate (DCR) value that may be in a range of 800 counts per second (cps) to 1200 cps. The term “dark count rate (DCR)” as used herein refers to measurement of number of photon triggering events per second due to thermal processes inside the photodetector 316. The DCR value may be preferably lower to achieve better results. Specifically, the DCR value may be preferably lower that may facilitate the receiver 304 to determine the second set of attributes with a greater accuracy. Preferably, the DCR value may be 1000 cps. The beam focusing mechanism 312 may be disposed at a side of the receiver 304 that may be exposed to the reflected version of the laser beam. In other words, the beam focusing mechanism 312 may be configured to receive the reflected version of the laser beam. The beam focusing mechanism 312 may be a telescope or a lens setup that may advantageously facilitate to focus the reflected version of the laser beam. Specifically, the beam focusing mechanism 312 may be configured to facilitate to focus the reflected version of the laser beam that may be reflected back after striking with the RSO 102a.

The filters 314 may be disposed adjacent to the beam focusing mechanism 312. Specifically, the filters 314 may be disposed downstream to the beam focusing mechanism 312 i.e., the reflected version of the laser beam may be travelled towards the filters 314 from the beam focusing mechanism 312. The filters 314 may be polarization filter and frequency filter. Specifically, the first filter 314a may be the polarization filter and the second filter 314b may be the wavelength filter. The filters 314 may be configured to facilitate to pass the received signal (light or signal) with certain wavelength, and direction of polarization (polarization direction). The received signal at the receiver 304 may consists of the reflected version of the beam along with noise that may be produced due to diffused light from stars and other celestial bodies in the space. The noise may be a light beam with multiple wavelength values and polarization directions. The reflected version of the laser beam will have the same wavelength values and polarization direction as that of the transmitted laser beam. Specifically, the first filter 314a may be configured to remove or filter the received signal such that undesired wavelength values is removed from the received signal. In other words, the first filter 314a may be configured to facilitate or allow the received signal with desired wavelength values to reach to the photodetector 316. Specifically, the second filter 314b may be configured to remove or filter the received signal such that the undesired polarization directions are removed from the received signal. In other words, the second filter 314b may be configured to facilitate or allow the received signal with desired polarization directions to reach to the photodetector 316. Therefore, the filters 314 may be configured to reduce noise level of the received signal.

In some embodiments of the present disclosure, the first filter 314a may be a linear type filter i.e., a linear polarization filter. Specifically, the first filter 314a may be configured to allow laser beam in one of, a horizontally polarized direction and a vertically polarized direction when the first filter 314a is rotated. Embodiments of the present disclosure are intended to include and/or otherwise cover the linear type filter that may allow to pass the reflected version of the laser beam in any polarization direction that may be perpendicular to the direction of propagation of the laser beam, without deviating from the scope of the present disclosure.

In some embodiments of the present disclosure, the first filter 314a may be a circular type filter i.e., a circular polarization filter. In some preferred embodiments of the present disclosure, the first filter 314a may be selected as the linear polarization filter and the circular polarization filter based on the polarization of the laser beam.

In some embodiments of the present disclosure, imaging unit 202 and the LIDAR unit 204 may have an additional filter (not shown). Specifically, the imaging unit 202, the transmitter 302, and the receiver 304 may have the additional filter. The additional filter may facilitate to provide radiation protection to the imaging unit 202, the LIDAR unit 204. Specifically, the additional filter may facilitate to provide the radiation protection to the imaging unit 202, the transmitter 302, and the receiver 304.

The photodetector 316 may be disposed adjacent to the filters 314. Specifically, the photodetector 316 may be disposed downstream to the filters 314 i.e., the reflected version of the laser beam may be travelled towards the photodetector 316 from the filters 314. The photodetector 316 may be configured to sense the reflected version of the laser beam. Specifically, the photodetector 316, based on the reflected version of the laser beam, determines the second set of attributes of the RSO 102a.

In some embodiments of the present disclosure, the photodetector 316 may be adapted to detect single photon. The photodetector 316 may advantageously detect single photons that may advantageously facilitate to determine the second set of attributes. For example, the photodetector 316 may be one of, a single photon avalanche diode (SPAD), an electron multiplying charge-coupled device (EMCCD), a plurality of silicon photomultipliers, and a Geiger-mode avalanche photodiode (GM-APD). The SPAD, the EMCCD, the plurality of photomultipliers, and the GM-APD may have single photon sensitivity. Embodiments of the present disclosure are intended to include and/or otherwise cover any type of known and later developed photodetectors that may facilitate to detect single photon in the reflected version of the laser beam, without deviating from the scope of the present disclosure.

In some exemplary embodiments of the present disclosure, the laser beam may have 375 pulses. In other words, the transmitter 302 may be configured to transmit the laser beam with 375 pulses for 1-2 seconds and the reflected version of the laser beam may have 27 pulses that may be received by the receiver 304. Embodiments of the present disclosure are intended to include and/or otherwise cover any value for the number of pulses of the laser beam, without deviating from the scope of the present disclosure.

In some embodiments of the present disclosure, the receiver 304 may include a baffle 318. The baffle 318 may be disposed at a periphery of the receiver 304. In other words, the baffle 318 may be attached or fixed at an internal periphery of the receiver 304. The baffle 318 may be configured to reduce the background noise that may come from other celestial bodies, for example, sun and stars.

In some embodiments of the present disclosure, the baffle 318 may be permanently attached to the receiver 304. In some other embodiments of the present disclosure, the baffle 318 may be removably attached to the receiver 304. In some embodiments of the present disclosure, the baffle 318 may be deployable. For example, while launching the object tracker 106 is launched, the baffle 318 may be in a stowed (folded) position such that the baffle 318 is deployed (unfolded) after launch.

In some embodiments of the present disclosure, the receiver 304 may have a length that may be in a range of 170 mm to 220 mm. Preferably, the receiver 304 may have the length that may be 200 mm. In some examples of the present disclosure, the beam focusing mechanism 312 may be 150 mm apart from the photodetector 316. Embodiments of the present disclosure are intended to include and/or otherwise cover any value for the length of the receiver 304 and the distance between the beam focusing mechanism 312 and the photodetector 316, without deviating from the scope of the present disclosure.

In some exemplary embodiments of the present disclosure, the laser mechanism 306 may be configured to produce the laser beam that may have the PRR value that may be 0.5 kHz. The transmitter 302 may be configured to emit the laser beam such that the laser beam has the PRR value of 0.5 kHz to track the RSO 102a with a size of 10 cm such that the RSO 102a (that is moving along the FOV of the imaging unit 202) is 89 Km apart from the object tracker 106. In such a scenario, the reflected version of the laser beam may be reflected back towards the receiver 304 upon striking with the RSO 102a in 1.5 seconds i.e., an integration time. Further, in such a scenario, the laser beam may have the average power of 20 W. In some other exemplary embodiments of the present disclosure, the laser mechanism 306 may be configured to produce the laser beam such that the laser beam may have the PRR value that may be 0.25 kHz. The average power, the integration time, and the PRR value may be related to a signal to noise ratio. The signal to noise ratio may increase upon decrease in the PRR value. The signal to noise ratio changes upon variation in the PRR value. The reflected version of the laser beam may have the signal to noise ratio that may be in a range of 0 to 6.7 dB. For example, the signal to noise ratio for the laser beam with the PRR value of 1 kHz and the average power of 20 W that reflects from a distance of 89 Km to the receiver 304 may be less than 0 decibel (dB). In some other examples, the signal to noise ratio for the laser beam with the PRR value of 0.5 kHz that reflects from a distance of 89 Km to the receiver 304 may be approximately equal to 0 dB. In some other examples, the signal to noise ratio for the laser beam with the PRR value of 0.25 kHz that reflects from a distance of 89 Km to the receiver 304 may be 2.63 dB. In some other examples, the signal to noise ratio for the laser beam with the PRR value of 0.25 kHz that reflects from a distance of 75 Km to the receiver 304 may be 4.2 dB. In some other examples, the signal to noise ratio for the laser beam with the PRR value of 0.25 kHz that reflects from a distance of 65 Km to the receiver 304 may be 6.26 dB. Embodiments of the present disclosure are intended to include and/or otherwise cover any value for the signal to noise ratio of the reflected version of the laser beam, without deviating from the scope of the present disclosure.

The transmitter 302 may be configured to emit the laser beam such that the laser beam has the PRR value of 0.25 kHz to track the RSO 102a with a size of 10 cm such that the RSO 102a (that is moving along the FOV of the imaging unit 202) is 89 Km apart from the object tracker 106. In such a scenario, the reflected version of the laser beam may be reflected back towards the receiver 304 upon striking with the RSO 102a in 1.5 seconds i.e., an integration time. Further, in such a scenario, the laser beam may have the average power of 20 W. In some other exemplary embodiments of the present disclosure, the laser mechanism 306 may be configured to produce the laser beam such that the laser beam may have the PRR value that may be 0.25 kHz. The transmitter 302 may be configured to emit the laser beam such that the laser beam has the PRR value of 0.25 kHz to track the RSO 102a with a size of 10 cm such that the RSO 102a (that is moving along the FOV of the imaging unit 202) is 75 Km apart from the object tracker 106. In such a scenario, the reflected version of the laser beam may be reflected back towards the receiver 304 upon striking with the RSO 102a in 1.5 seconds i.e., an integration time. Further, in such a scenario, the laser beam may have the average power of 20 W. In some other exemplary embodiments of the present disclosure, the laser mechanism 306 may be configured to produce the laser beam such that the laser beam may have the PRR value that may be 0.25 kHz. The transmitter 302 may be configured to emit the laser beam such that the laser beam has the PRR value of 0.25 kHz to track the RSO 102a with a size of 10 cm such that the RSO 102a (that is moving along the FOV of the imaging unit 202) is 65 Km apart from the object tracker 106. In such a scenario, the reflected version of the laser beam may be reflected back towards the receiver 304 upon striking with the RSO 102a in 1.5 second i.e., an integration time s. Further, in such a scenario, the laser beam may have the average power of 20 W. The object tracker 106 may therefore be configured to track the RSO 102a that is 89 Km apart with the lower PRR value of the laser beam. Embodiments of the present disclosure are intended to include and/or otherwise cover any value for the PRR, any dimension for the RSO 102a that may be positioned at any distance from the object tracker 106, without deviating from the scope of the present disclosure.

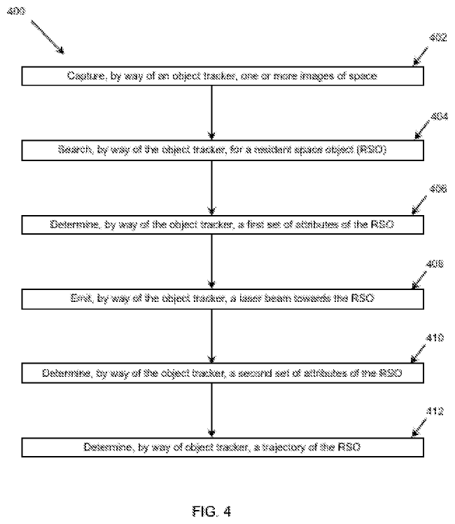

FIG. 4 illustrates a flowchart that depicts a method 400 for tracking the resident space object 102a, in accordance with an embodiment of the present disclosure. The method 400 may include following steps for tracking the resident space object 102a: —

At step 402, the object tracker 106 may be configured to capture the one or more images of the space around the object tracker 106. Specifically, the imaging unit 202 may be configured to capture the one or more images of the space around the object tracker 106.

At step 404, the object tracker 106 may be configured to search for the RSO 102a in the space around the object tracker 106. Specifically, the imaging unit 202 may be configured to search for the RSO 102a in the space around the object tracker 106.

At step 406, the object tracker 106 may be configured to determine the first set of attributes of the RSO 102a at the first time interval (t1). Specifically, the imaging unit 202 may be configured to determine the first set of attributes of the RSO 102a at the first time interval (t1) upon detection of the RSO 102a. The first set of attributes may include, but not limited to, an azimuthal angle and an elevation angle associated with the RSO 102a. The first set of attributes of the RSO 102a may represent the angular position of the RSO 102a in the LEO region 104 at the first time interval (t1). The imaging unit 202 may be configured to transmit the first set of attributes to the LIDAR unit 204. Specifically, the imaging unit 202 may be configured to transmit the first set of attributes to the LIDAR unit 204 by way of the communication channel 208.

At step 408, the object tracker 106 may be configured to emit the laser beam towards the RSO 102a based on the first set of attributes. Specifically, the LIDAR unit 204 may be configured to emit the laser beam towards the RSO based on the first set of attributes. The LIDAR unit 204 may be configured to receive the first set of attributes from the imaging unit 202. Specifically, the LIDAR unit 204 may be configured to receive the first set of attributes from the imaging unit 202 through the communication channel 208. The LIDAR unit 204 may be configured to activate upon receipt of the first set of attributes from the imaging unit 202. The LIDAR unit 204 may be configured to emit the laser beam towards the RSO 102a upon activation. The LIDAR unit 204 may be configured to emit the laser beam towards the RSO 102a based on the first set of attributes. In other words, the LIDAR unit 204 may emit the laser beam at the angular position of the RSO 102a that may advantageously facilitate the laser beam to efficiently strike on the RSO 102a.

At step 410, the object tracker 106 may be configured to determine the second set of attributes of the RSO 102a at the second time interval (t2). Specifically, the LIDAR unit 204 may be configured to determine the second set of attributes of the RSO 102a upon receiving the reflected version of the laser beam. In other words, the LIDAR unit 204 may be configured to determine the second set of attributes based on the laser beam and the reflected version of the laser beam that may be received upon striking of the laser beam with the RSO 102a. The second set of attributes of the RSO 102a may include, but not limited to, a range or distance of the RSO 102a at the second time interval (t2). The laser beam may have the pulse repetition rate (PRR) value that may be in a range of 0.25 kHz to 1 kHz.

At step 412, the object tracker 106 may be configured to determine the position, velocity, acceleration, orbit or state vector and trajectory of the RSO 102a. Specifically, the processing circuitry 206 may be configured to determine the position, velocity, acceleration, orbit or state vector and trajectory of the RSO 102a based on the first and second sets of attributes. The processing circuitry 206 may be configured to receive the first set of attributes from the imaging unit 202 and the second set of attributes from the LIDAR unit 204. Specifically, the processing circuitry 206 may be configured to receive the first and second sets of attributes from the imaging unit 202 and the LIDAR unit 204, respectively, through the communication channel 208. The processing circuitry 206 may be configured to determine the position, velocity, acceleration, orbit or state vector and trajectory associated with the RSO 102a. Specifically, the processing circuitry 206 may be configured to determine the position, velocity, acceleration, orbit or state vector and trajectory of the RSO 102a based on the first and second set of attributes. For example, the processing circuitry 206 may be configured to determine the position, velocity, acceleration, orbit or state vector and trajectory of the RSO 102a based on the angular position and the range of the RSO 102a. The position of the RSO 102a may represent a path that may be travelled by the RSO 102a in the FOV of the imaging unit 202.

Thus, the object tracker 106 may advantageously facilitate to determine position, velocity, acceleration, orbit or state vector and trajectory of the RSO 102a with respect to the object tracker 106. Since, the object tracker 106 tracks the RSO 102a, while residing in the space, therefore, the object tracker 106 captures more finer details of the RSO 102a instead of the ground-mounted infrastructures which are woefully inadequate as the ground-mounted infrastructures tracks less than 4% of lethal RSOs 102. The object tracker 106 may advantageously provide better insights of the RSO 102a that may advantageously facilitate to plan various space missions efficiently. The object tracker 106 may advantageously have a suitable design and form factor that may allow the object tracker 106 to be implemented in multiple satellites and other space-based platforms. Since, the object tracker 106 resides in space, while determining the position of the RSO 102a, therefore there are very less or negligible atmospheric losses while determining the position of the RSO 102a. The object tracker 106 may advantageously characterize one or more errors or uncertainties in the position of the RSO 102a. The successive positions of the RSO 102a may advantageously facilitate to determine orbit or state vector of the RSO 102a. The errors or uncertainties in the position of the RSO 102a may be used to determine uncertainty metrics in the orbit or state vector of the RSO 102a. The object tracker 106 may advantageously be adapted to determine respective positions of various RSOs simultaneously.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim(s):

1. An object tracker (106) comprising:
an imaging unit (202) configured to capture one or more images of space around the object tracker (106) to search for a resident space object (RSO) (102a) in the space such that, upon detection of the RSO (102a), the imaging unit (202) determines a first set of attributes of the RSO (102a) at a first time interval (t1); and
a light detection and ranging (LIDAR) unit (204) coupled to the imaging unit (202) and configured to activate upon receipt of the first set of attributes from the imaging unit (202) such that the LIDAR unit (204) emits, based on the first set of attributes, a laser beam towards the RSO (102a) to determine a second set of attributes of the RSO (102a) at a second time interval (t2).

2. The object tracker (106) as claimed in claim 1, further comprising processing circuitry (206) coupled to the imaging unit (202) and the LIDAR unit (204) and configured to determine a position, velocity, acceleration, orbit or state vector and trajectory of the RSO (102a) based on the first and second sets of attributes.

3. The object tracker (106) as claimed in claim 1, wherein the LIDAR unit (204) comprising:
a transmitter (302) configured to transmit the laser beam towards the RSO (102a); and
a receiver (304) configured to receive reflected version of the laser beam upon striking of the laser beam with the RSO (102a), wherein the laser beam and the reflected version of the laser beam facilitates to determine the second set of attributes.

4. The object tracker (106) as claimed in claim 3, wherein the transmitter (302) comprising:
a laser mechanism (306) configured to produce the laser beam;
a divergence mechanism (308) coupled to the laser mechanism (306) and configured to facilitate divergence of the laser beam;
a steering mechanism (310) coupled to the divergence mechanism (308) and configured to guide the laser beam based on the first set of attributes such that the laser beam strikes the RSO (102a).

5. The object tracker (106) as claimed in claim 3, wherein the receiver (304) comprising:
a photodetector (316) configured to sense the reflected version of the laser beam such that the photodetector (316), based on the laser beam and the reflected version of the laser beam, determines the second set of attributes; and
a pair of filters (314a, 314b) that are disposed ahead of the photodetector (316) such that the pair of filters (314a, 314b) reduce noise level of the reflected version of the laser beam.

6. The object tracker (106) as claimed in claim 5, wherein the photodetector (316) is a single photon avalanche diode.

7. The object tracker (106) as claimed in claim 1, wherein the first set of attributes comprising an azimuthal angle and an elevation angle associated with the RSO (102a).

8. The object tracker (106) as claimed in claim 1, wherein the second set of attributes comprising a range associated with the RSO (102a).

9. A method (400) for tracking a resident space object (RSO) (102a), the method (400) comprising:
capturing (402), by way of an imaging unit (202), one or more images of space around an object tracker (106);
searching (404), by way of the imaging unit (202), for the RSO (102a) in the space;
determining (406), by way of the imaging unit (202), a first set of attributes of the RSO (102a) at a first time interval (t1) upon detection of the RSO (102a);
emitting (408), by way of a light detection and ranging (LIDAR) unit (204) coupled to the imaging unit (202), a laser beam towards the RSO (102a) based on the first set of attributes; and
determining (410), by way of the LIDAR unit (204), a second set of attributes of the RSO (102a) at a second time interval (t2) upon receiving the reflected version of the laser beam.
